(19) United States
(12) Patent Application Publication
(10) Pub. No.: US 2010/0061729 A1
(43) Pub. Date: Mar. 11, 2010

(54) Method and system for optical transmission

(76) Inventor: William B. Weeber, Raleigh, NC (US)

Correspondence Address: Docket Administrator - Room 3D-201E;Alcatel-Lucent USA Inc., 600-700 Mountain Avenue, Murray Hill, NJ, 07974, US

(21) Appl. No.: 12/584,263

(22) Filed: Sep. 2, 2009

Related U.S. Application Data
(60) Provisional application No. 61/190,746, filed on Sep. 2, 2008.

(51) Int. Cl. H04J 14/02

(52) U.S. Cl. 398/71; 398/70

(57) ABSTRACT

A system and method for optical transmission that provides an efficient manner of increasing transmission capacity, especially in the downstream direction, with minimal changes to existing components. An optical network node includes an optical transmitter, a plurality of optical media access controllers, and a bit interleaver for interleaving the output of each of the plurality of optical media access controllers into a single bit stream and providing the bit stream to the optical transmitter. In operation, the optical network node, which may be an OLT, thereby is capable of transmitting at a rate equal to the sum of the output rates of the individual media access controllers. A corresponding deinterleaver in a receiving node, such as an ONT, separates the interleaved bit stream into its constituent bit streams, one or more of which may be selected for use in the receiving device.

### CROSS-REFERENCE TO RELATED APPLICATIONS AND CLAIM OF PRIORITY

The present disclosure is related to and claims priority from U.S. Provisional Patent Application Ser. No. 61/190,746, filed on 2 Sep. 2008, the entire contents of which are incorporated by reference herein.

### TECHNICAL FIELD

The present invention relates generally to the field of optical communication networks, and, more particularly, to a method and system for efficiently transmitting signals via an optical network such as a passive optical network (PON).

### BACKGROUND

The following abbreviations are herewith defined, at least some of which are referred to within the following description of the state-of-the-art and the present invention.
FTTH fiber to the home
FTTU fiber to the user
GEM GPON encapsulation method
GPON gigabit-capable PON
IETF Internet Engineering Task Force
ITU International Telecommunication Union
LOS/LOF Loss of Signal/Loss of Frame
MAC medium access control
MDU multi-dwelling unit
ODN optical distribution network
OLT optical line termination
ONT optical network termination
ONU optical network unit
PLL phase-locked loop
PON passive optical network
SN serial number
SNI service node interface
TDMA time division multiple access
UNI user-network interface
WDM wave division multiplexing

Optical telecommunication networks have been widely built out in recent years and are gaining in popularity. Optical fibers are capable are capable of carrying a high volume of traffic at a reasonable cost. Although previously the “last mile” between an optical communication network and the end user was still spanned with copper wire, now fiber optic cables are often run directly up to houses, apartment complexes, and business locations. One arrangement for spanning this portion of the communication link is referred to as a PON.

Generally speaking, a PON includes an OLT, typically located in a central office, which communicates via a fiber-optic cable system with one or more ONUs, with each ONU being located on or near a customer premises. An ONT is an ONU that typically serves a single user and may, for example, be located at the user's residence. An MDU is an ONU that serves a multi-dwelling unit such as an apartment complex or small business. Each ONU is capable of segregating the downstream signals from the OLT and directing them to the proper user, and of transmitting upstream signals back to the OLT. In addition to forming a part of one or more PONS, the OLT is also connected to the larger telecommunication system through which the various services such as telephony,

Internet access, and broadcast media are accessible so that they can be made available to the users associated with the OLT.

Standards have been promulgated for PON operations. For example, many current implementations are configured in accordance with a family of specifications including ITU-T G.984 and related standards. Such systems currently provide for transmission speeds of up to (approximately) 2.5 Gbps in the downstream direction and 1.24 Gbps upstream. The directional difference in transmission speeds is due in part to practical consideration of the cost of facilitating higher upstream transmission speeds, coupled with the fact that, as a general rule, more content needs to be transmitted downstream than back to the OLT.

With increased utilization of optical network services, however, there is a need to increase existing transmission speeds, at least in the downstream direction and eventually in both directions. One solution, of course, is to simply replace or upgrade all PON and related equipment with the components necessary to accommodate the higher transmission speeds. This, however, may be too expensive or difficult, especially in the near term. In some cases there may be technical obstacles as well. There is a need, therefore, for a way to facilitate an increase in transmission speed without having to replace or upgrade all of the components in each OLT and ONU.

### SUMMARY

The present invention is directed to a manner of efficiently transmitting optical signals in an optical network such as a PON to extend the transmission capability of existing resources while necessitating only a relatively-small, if any, modification of existing hardware.

In one aspect, the present invention is an optical network node that include an optical transmitter, a plurality of optical media access controllers, and a bit interleaver for interleaving the output of each of the plurality of optical media access controllers into a single bit stream and providing the bit stream to the optical transmitter. The node may also include a phase-lock loop coupled to the bit interleaver and to each of the plurality of optical media access controllers. In a preferred embodiment, the network node is an OLT in a PON, and transmits downstream at a transmission rate approximately equal to the sum of the operating rates of the plurality of media access controllers. In one embodiment he network node interleaves the plurality of bit streams into a single bit stream by selecting a bit from each of the media access controllers in turn, but in some implementations another scheme may be used. In most embodiments the network node includes an optical receiver and upstream MAC for receiving and processing upstream transmissions. In some implementations it will have a plurality of optical receivers and upstream MACs for receiving WDM-separated upstream transmissions from a plurality of MACs.

In another aspect, the present invention is a method of transmitting an optical signal within a passive optical network including receiving, by a bit interleaver of an optical network node, the output of a plurality of media access controllers, interleaving the output of the plurality of media access controllers to create a single bit stream, and providing the single bit stream to an optical transmitter. Again, in a preferred embodiment, the optical network node is an OLT operating in a PON, such as a GPON. The method may further include transmitting the bit stream via a passive optical network and receiving the bit stream in an optical receiver where it is deinterleaved.

In yet another aspect, the present invention is a system for optical communication that includes an OLT having a bit interleaver, and at least one ONU having a deinterleaver in communication. The ONU preferably includes at least one channel selector.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified block diagram illustrating selected components of an exemplary optical network in which the present invention may be implemented;

FIG. 2 is a simplified block diagram illustrating selected components of an OLT according to an embodiment of the present invention;

FIG. 3 is a simplified block diagram illustrating selected components of an optical network according to an embodiment of the present invention;

FIG. 4 is a simplified block diagram illustrating selected components of an optical network according to embodiment of the present invention;

FIG. 5 is a simplified block diagram illustrating the interleaving of a plurality of bit streams according to an embodiment of the present invention;

FIG. 6 is a simplified block diagram illustrating the deinterleaving of a bit stream according to an embodiment of the present invention;

FIG. 7 is a simplified block diagram illustrating selected components of an OLT according to an alternate embodiment of the present invention;

FIG. 8 is flow diagram illustrating a method of transmitting via an optical network according to an embodiment of the present invention;

FIG. 9 is a simplified block diagram illustrating selected components of an optical network according to an alternate embodiment of the present invention; and

FIG. 10 is a state diagram illustrating a process of channel assignment according to an embodiment of the present invention.

### DETAILED DESCRIPTION

The present invention is directed to a manner of facilitating higher transmissions speed in a PON operating according to a current standard, for example ITU-T G.984 and related specifications. FIG. 1 is a simplified block diagram illustrating selected components of an exemplary optical network, in this case a PON, 100 in which the present invention may be implemented.

In the embodiment of FIG. 1, PON 100 includes an OLT 150 configured according to the present invention and operable to communicate with a telecommunication system (not shown) providing services to a number of users (also not shown) that are associated with OLT 150 and accessible via PON 100. PON 100 also includes an ONT 110, which serves a single user, and MDU 130, which is capable of serving four users. Note that the number of users is exemplary, and could vary from implementation to implementation. The number of ONUs such as ONT 110 and MDU 130 may also vary, though a typical implementation may have as many as thirty-two or sixty-four. The OLT 150 is connected to ONT 110 and MDU 130 via an optical fiber system 101. Optical fiber system 101 includes a fiber-optic cable and typically one or more un-powered optical splitters that enable a single OLT to communicate with many ONUs, as implied in FIG. 1 although only ONT 110 and MDU 130 are illustrated.

In some cases the present invention may be implemented in other types of networks that are similar in operation, and the invention is not intended to be limited to only those networks or components that are labeled or referred to by now-current terminology.

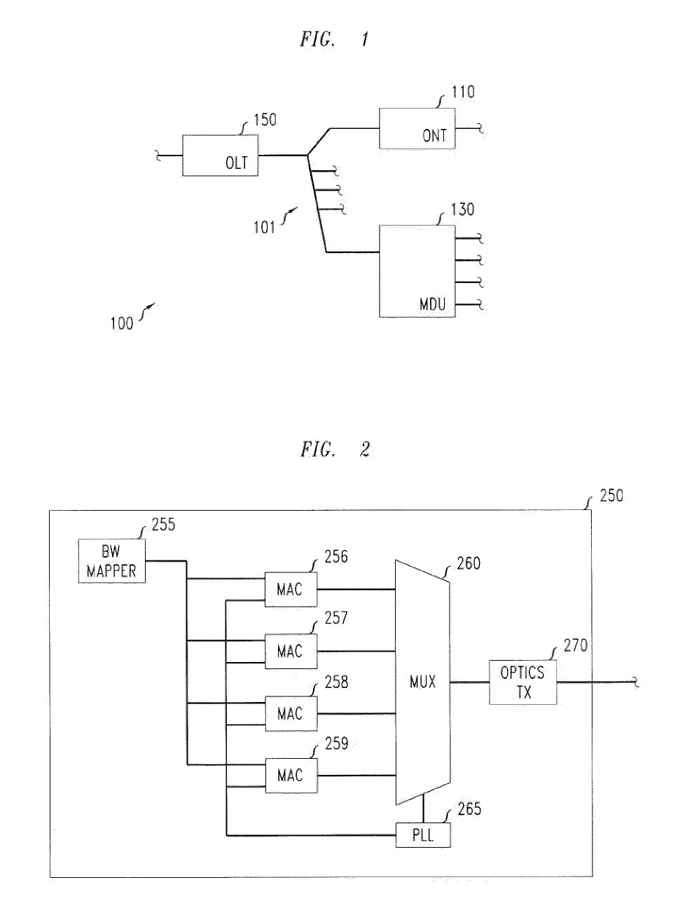

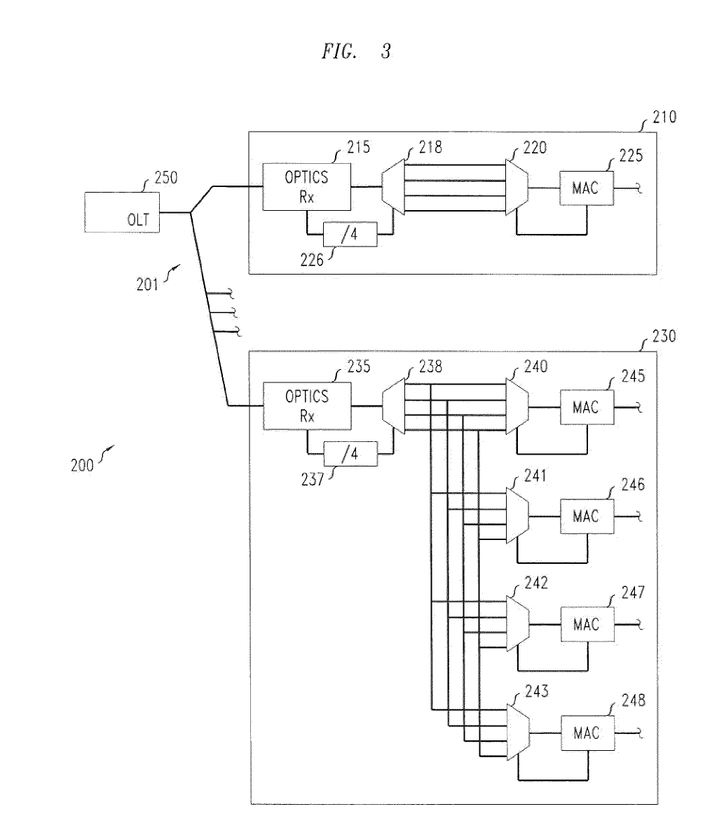

FIG. 2 is a simplified block diagram illustrating selected components of an OLT 250 configured according to an embodiment of the present invention. Generally speaking, downstream transmission components are shown in FIG. 2. In accordance with this embodiment of the present invention, communication capacity over a fiber optic cable system is increased by bit interleaving the input of multiple MACs prior to transmission. In the embodiment of FIG. 2, there are shown four MACs, referred to as 256 through 259, each providing input from an external communication system (not shown), that is to be transmitted by OLT 250 to one or more users. In FIG. 2, MACs also receive input from bandwidth mapper 255 so that downstream transmissions also include instructions for timing upstream transmissions. A PLL 265 works in conjunction with a multiplexer 260 and the MACs to insure proper synchronization and timing.

In this embodiment, each of the MACs 256 through 259 provide their output to multiplexer 260, which bit interleaves the output from each of the MACs into a single bit stream. In a preferred embodiment, the bits from each MAC are selected in turn so that the input from each MAC is equally represented in the output bit stream, although in some implementations a different selection scheme may be used. The bit stream output is then provided to an optical transmitter 270 for transmission on an optical fiber.

In a preferred embodiment, the optical transmission capacity of the optical transmitter 270 is approximately equal to or greater than the sum of the capacities of the individual MACs. For example, if each MAC is capable of outputting approximately 2.5 Gbps in the downstream directions, the optical transmitter would be capable of transmitting at 10 Gbps to take full advantage of the increased capacity. Note that herein all transmission speeds mentioned are taken to be approximate values, as is currently customary in describing telecommunication system capacity.

Naturally, this embodiment also presumes that the multiplexer 260 is capable of outputting a 10 Gbps bit stream, as is the case in a preferred embodiment. Of course, even a smaller improvement over the 2.5 Gbps that transmitter 270 would normally transmit using a single MAC is still advantageous. It should be noted here that while the use of 2.5 Gbps MACs is consistent with many current implementations, the same configuration may be used with four 10 Gbps MACs to produce a 40 Gbps bit stream, given an appropriate multiplexer and optical transmitter. Finally, it is noted that more or less than four MACs may be used to provide input to the multiplexer. In one embodiment, the available MAC capacity may be dynamically adjustable. The use of OLT 250 in an exemplary network will now be illustrated.

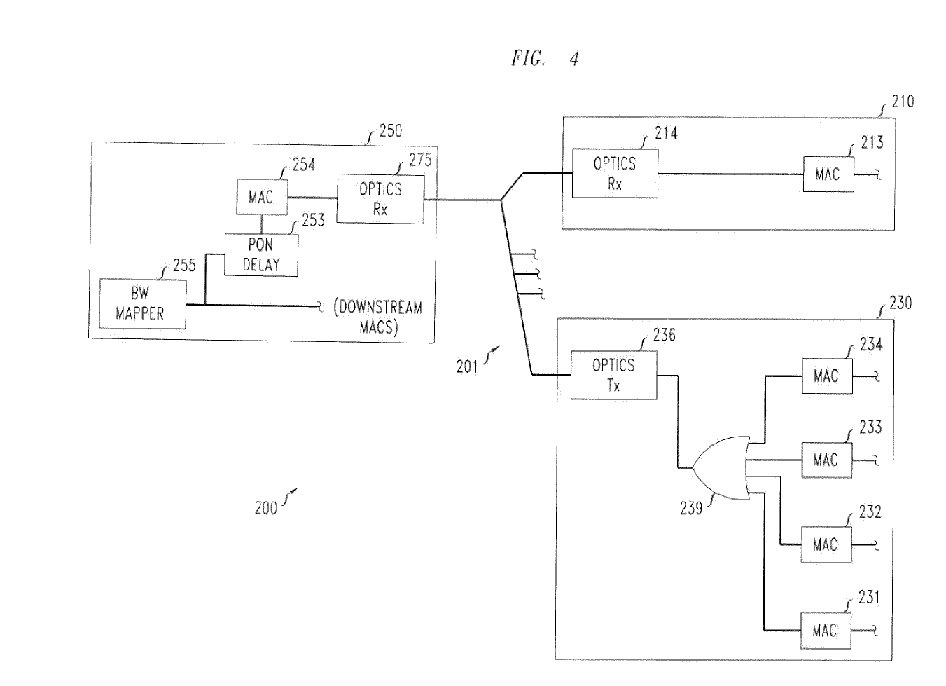

FIG. 3 is a simplified block diagram illustrating selected components of an optical network 200 according to an embodiment of the present invention. In this embodiment, optical network 200 is a PON and includes OLT 250, described above. Also shown are two ONUs, ONT 210 and MDU 230. As is implied by the depiction of optical fiber system 201, which interconnects these components, a number of other ONUS may be, and usually are present as well. ONT 210 and MDU 230 are exemplary of the other ONUS, but it is not necessary that all ONUS are identically configured.

In this embodiment, ONT 210 includes an optical receiver 215, which receives downstream transmissions from OLT 250 via optical fiber system 201. Naturally, optical receiver 215 is capable of receiving transmissions from optical transmitter 270 of ONT 250 (shown in FIG. 2). For example, if optical transmitter 270 transmits downstream at 10 Gbps, then optical receiver 215 receives at the same rate. Once received, the bit stream from OLT 250 is provided to demultiplexer 218 where it is separated into its original constituent bit streams. In this embodiment, these correspond to the four MACs of OLT 250 (also shown in FIG. 2), and a divide-by-four function 226 is present to allow the demultiplexer 218 to recreate the constituent streams. As illustrated in FIG. 3, the four bit streams are then provided to channel selector 220, which selects one of the bit streams at the direction of downstream MAC 225. The selected bit steam is then provided to MAC 225 and electronically processed as usual.

Similarly, MDU 230 includes optical receiver 235, which also receives the optical transmission from optical transmitter 270 (shown in FIG. 2). Once received, the bit stream from OLT 250 is provided to demultiplexer 238 where it is separated into its original constituent bit streams. In this embodiment, these correspond to the four MACs of OLT 250 (also shown in FIG. 2), and a divide-by-four function 237 is present to allow the demultiplexer 218 to recreate the constituent streams. MDU 230 serves multiple users (not shown), and includes multiple downstream MACs 245 through 248. Each of MACs 245 through 248 direct a respective channel selector 240 though 243 to select a bit stream from the four provided by demultiplexer 238. Note that the four MACs 245 through 248 of MDU 230 may but do not necessarily correspond respectively to the four MACs 256 though 259 of OLT 250 (shown in FIG. 2).

In this manner, the present invention provides an efficient network-capacity upgrade in the downstream direction. The basic electronics and MACs functions may remain the same while an increase in transmission rate is achieved via the bit interleaving technology, supported (if necessary) by ensuring that the optics modules of each respective component are able to accommodate the increased rate. Adding only the bit interleaving components is in most implementations a much lower cost operation than upgrading all components and making corresponding protocol adjustments. Existing optical fiber systems, including the optical splitters, will in most cases support operation of the present invention without expensive upgrade.

In the upstream direction, one alternative is simply to employ existing techniques in conjunction with the downstream enhancements according to the present invention. Although upstream capacity improvements may be needed more urgently in the future, present demand remains manageable with existing systems. One embodiment of the network of the present invention is illustrated in FIG. 4. FIG. 4 is a simplified block diagram illustrating selected components of an optical network 200 according to an embodiment of the present invention. In this embodiment, OLT 250 includes a single bandwidth mapper 255 for managing transmissions in the upstream direction. Optical receiver 275 receives the upstream signals and provides the received transmission to upstream MAC 254. A PON delay function 253 in this embodiment accounts the differences in physical distance from the OLT 250 and may adjust the bandwidth map generated by bandwidth mapper 255 accordingly.

This bandwidth map, for example, provides a transmission window for upstream transmissions from MAC 213 of ONT 210 via the optical transmitter 214. The same is true for MDU 230, which includes an OR function 239 between its multiple upstream MACs 231 through 234 and the optical transmitter 236 of MDU 230. This embodiment thereby provides for traditional TDMA upstream transmission, with each ONU transmitting in burst mode over optical fiber system 201 during its assigned time slot.

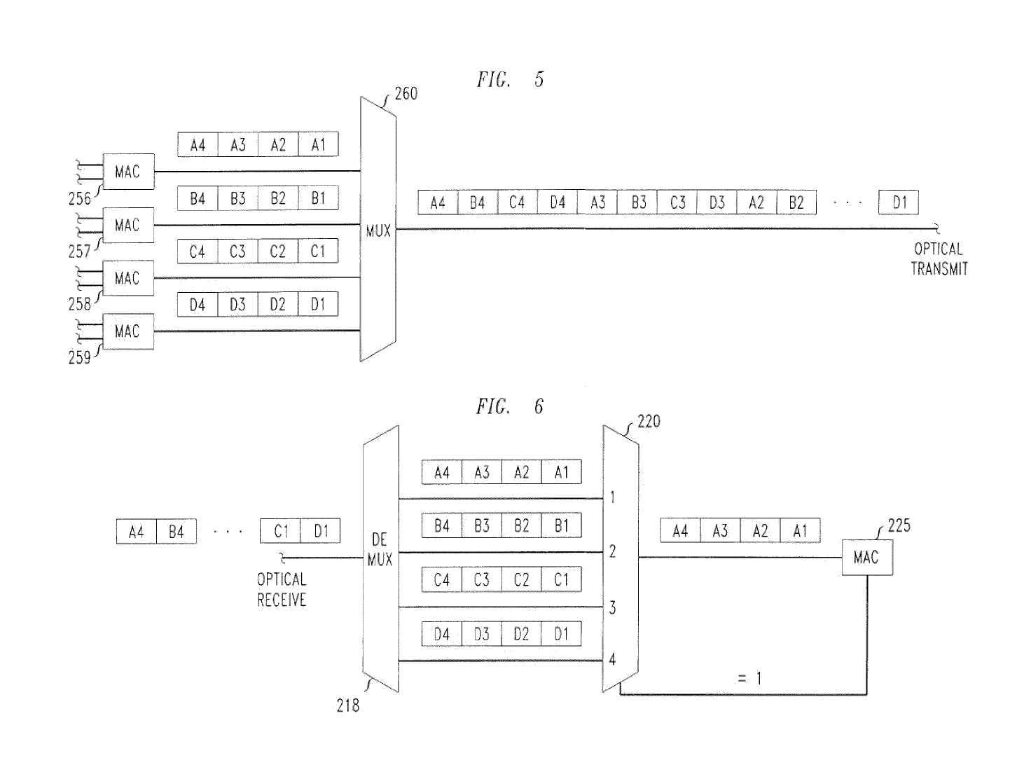

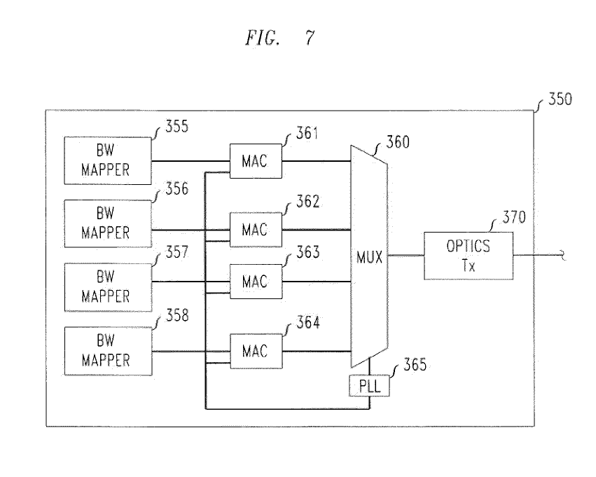

The downstream transmission interleaving process is illustrated in more detail in FIGS. 5 and 6. FIG. 5 is a simplified block diagram illustrating the interleaving of a plurality of bit streams according to an embodiment of the present invention. In the embodiment of FIG. 5, MAC 256 produces a bit stream and provides it to multiplexer 260. For convenience, the bit stream produced by MAC 256 is represented as bits A1 through A4. Similarly, downstream bit streams from MACs 257 through 259 are respectively shown as bits B1 through B4, C1 through C4, and D1 through D4. In the exemplary implementation referred to above, each of these separate bit streams are received at a rate of approximately 2.5 Gbps. Multiplexer 260 than creates a single 10 Gbps bit stream by selecting one bit from each of the separate streams, in order, and interleaving them as illustrated in FIG. 5. The interleaved bit stream is then provided to optical transmitter 270 (see FIG. 2) for transmission from OLT 250. As alluded to above, in some implementations (not shown) a different bit selection or interleaving scheme may be employed.

FIG. 6 is a simplified block diagram illustrating the deinterleaving of a bit stream according to an embodiment of the present invention. When this interleaved bit stream arrives at a destination, for example optical receiver 215 (shown in FIG. 3), it is again divided into its four separate bit streams by demultiplexer 218. This separation in effect creates four “channels”. As shown in FIG. 6, when downstream MAC 225 selects channel 1, selector 220 provides it with (exemplary) bits A1 through A4. MAC 225 may have determined that this bit stream is intended for it, or may have made an arbitrary selection which may be modified later if the wrong bit stream is selected.

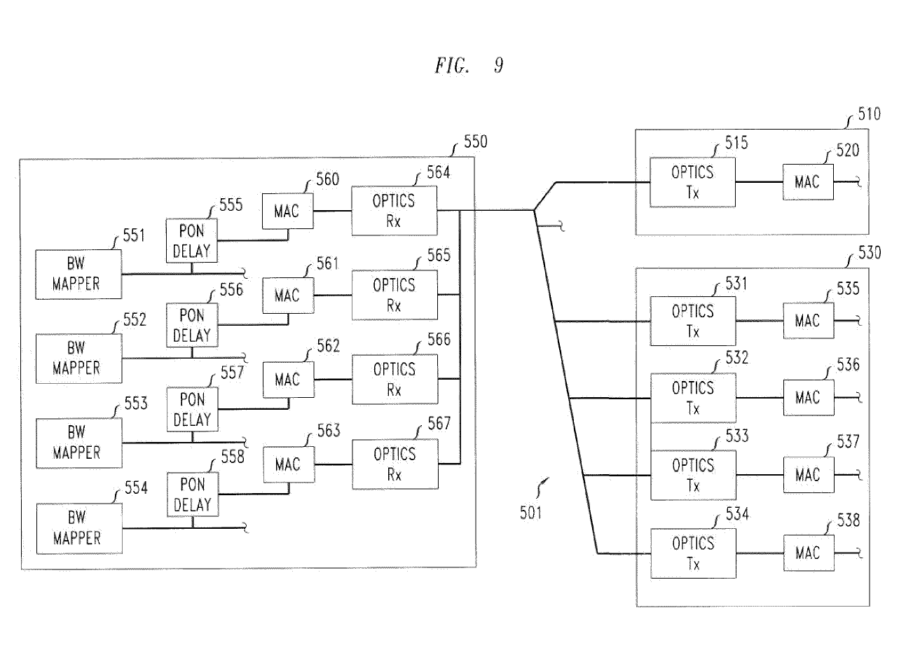

FIG. 8 is a flow diagram illustrating a method 400 of transmitting via an optical network, such as a PON, according to an embodiment of the present invention. The method 400 presumes that the components for performing the method, for example those described above, are available and operational. The method then begins with the receipt of content (step 405) in the plurality of MACs in an optical network node, such as an OLT. “Content” is used here to refer broadly to information and data to be provided to users via the optical network. In some implementation it may refer to control signaling as well. The manner in which this content is provided to each of the MACs (illustrated, for example, in FIG. 2) is otherwise outside of the scope of this disclosure. Each of the MACs then creates a bit stream representing the content it has received and provides it to a multiplexer (step 410).

In this embodiment, upon receiving the bit streams from each MAC interleaves them into a single bit stream (step 415). This single bit stream represents the output of each of the individual MACs of the node, it is transmitted as a single bit stream (step 420) by an optical transmitter to an ONU, where it is received (step 425). When the single interleaved bit stream is received, it, is provided to a demultiplexer and separated into its constituent bit streams associated with the downstream MACs of the OLT. Taking as an example the channel selector 220 of FIG. 6, in the embodiment of FIG. 8 a channel selector then selects (step 435) one of these constituent bit streams and provides it to a MAC for further processing.

In this embodiment, the MAC, for example MAC 225 shown in FIG. 6, has selected a channel arbitrarily. The MAC is not aware which bit stream will appear on this channel, but it is able to recognize the bit stream that is intended for it. When the channel selector provided the bit stream associated with the selected channel to the MAC, the MAC determines whether the channel has been selected properly (step 440). If not, the channel selection (step 435) and verification (step 440) is performed again. In most implementations, the channel selector simply steps through the available channels until the correct bit stream is chosen. Thereafter, the intended content is provided to the MAC (step 445) until it has all been transmitted or some event (not shown) necessitates that the channel selection process needs to be performed again.

Note that the operations illustrated in FIG. 8 are exemplary of one embodiment; in alternate embodiments other operations may be added or in some cases removed without departing from the spirit of the invention. In addition, the sequence shown is not necessarily mandatory, and the operations may in other embodiments be performed in any logically-consistent order.

In some implementations, it will be necessary or desirable to provide a manner of identifying a channel for selection by the receiving MAC. This may be done in a number of ways. For example, in a GPON network operating under the G.984 protocol, the bits of the Psync frame may be modified to distinguish between channels. Other fields may be used as well.

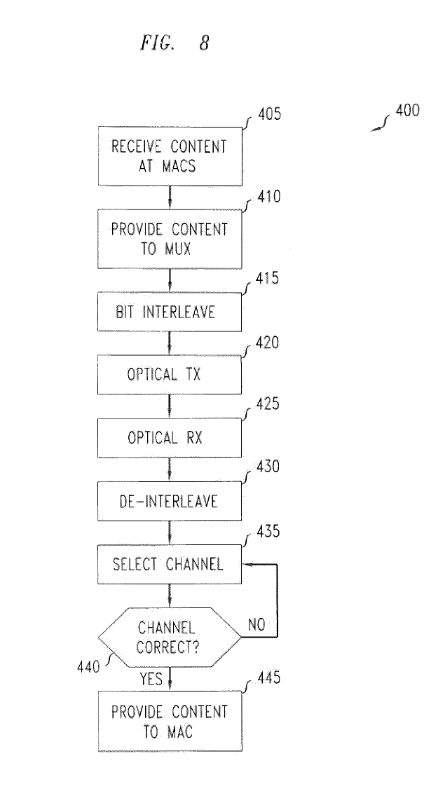

The optical network components are not limited to the configurations illustrated above. For example, FIG. 7 illustrates an alternate OLT configuration. FIG. 7 is a simplified block diagram illustrating selected components of an OLT 350 according to an alternate embodiment of the present invention. In the embodiment of FIG. 7, OLT 350 includes four MACs 361 through 364, each of which output to a multiplexer 360 in the downstream direction, and each of which receive input from an associated PLL 365. Each of the MACs 361 through 364, however, is associated with a respective one of the bandwidth mappers 355 through 358. This can create a one to one correspondence with downstream components, each of which may then transmit simultaneously in the upstream direction using WDM. Note that in the downstream direction, however, the multiplexer 360 again interleaves the output of each MAC 361 thorough 364 and provides the resulting single interleaved bit stream to the optical transmitter 370.

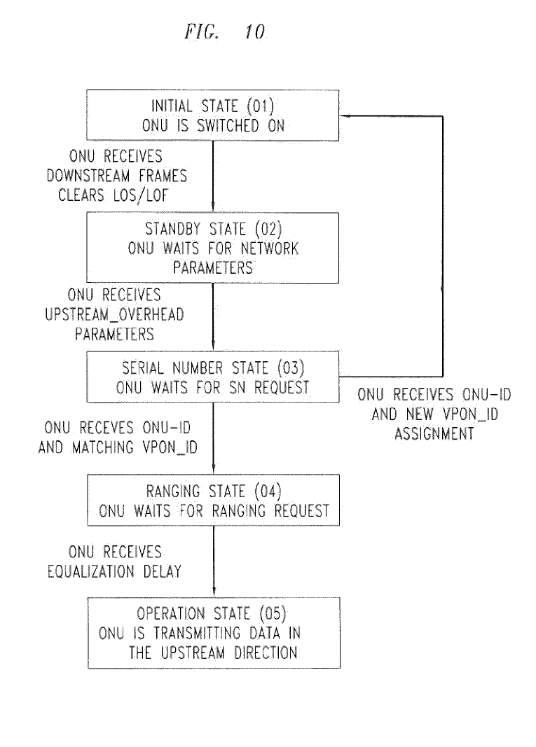

FIG. 9 is a simplified block diagram illustrating selected upstream components of an optical network 500 according to an alternate embodiment of the present invention. This embodiment is compatible with the OLT 350 of FIG. 7, and OLT 550 may be but is not necessarily an upstream counterpart. In this embodiment, ONT 510 and MDU 530 are again in communication with OLT 550 via a optical fiber system 501. ONT 510 includes an upstream MAC coupled to an optical transmitter, which transmits upstream according to the instructions of a bandwidth map received from the OLT 550. In this sense, the ONT 510 is similar to the ONT 210 of FIG. 4.

Returning the embodiment of FIG. 9, MDU 530 includes four optical transmitters 531 through 534, each corresponding to one of the MACs 535 through 538. In this embodiment, each of the transmitters 531 through 534, in cooperation with their associated MAC, transmits upstream using a different wavelength. For this reason they can (but are not required to) each transmit via optical fiber system 501 at the same time. Corresponding receivers 564 through 567, each attuned to a different one of these wavelengths, accept the transmission only from the appropriate MAC. Each receiver 564 through 567 then provides the received signal to an associated upstream MAC for further processing. Note that each of the MACs 560 through 563 is associated with a respective bandwidth mapper 551 through 554 and PON delay function 555 through 558. In this manner, four virtual PONs are created for transmission in the upstream direction. Note that while each of the four virtual PON channels associated with transmission in the upstream direction may transmit (at, for example, 2.5 Gbps) at the same time, these transmissions are separated by WDM and not (in this embodiment) combined using bit interleaving as in the downstream direction.

FIG. 10 is a state diagram illustrating a process of channel assignment according to an embodiment of the present invention. It is noted that the state diagram of FIG. 10 is in some respect similar to FIG. 10-1 of the G.984.3 specification, from which it is derived. Returning to FIG. 10, at initial state (01) occurs when an ONU configured according to the present invention is switched on. At this state, the ONU asserts LOS/LOF, which clears when it receives downstream frames. The ONU then enters standby state (02) and waits for network parameters. Once the Upstream_Overhead Parameters message is received, the ONU reconfigures accordingly and moves to SN state (03), where it waits for a SN Request. According to the embodiment of FIG. 10, when the ONU receives an SN request and responds to the OLT, it receives an ONU-ID and VPON-ID. The VPON_ID may in some embodiments be used to distinguish upstream transmissions from the ONU, and to allow the ONU to identify the channel on which it is to receive downstream transmissions. If the received VPON_ID matches the ONU-ID, the ONU transitions to ranging state (04). If the VPON_ID is a new assignment, the ONU returns to initial state (01). The ONU preferably retains its VPON_ID in a non-volatile memory so that it's remembered on restart and subsequent ranging will be able to select correct the correct channel. In one embodiment, an unspecified Assign_ONU-ID field is used to make the VPON-ID assignment, and the Modify Serial_Number_ONU message may be used to pass the current VPON-ID upstream to the OLT.

According to this embodiment, when the ONU reaches the ranging state (04), it waits for a ranging request and a determination is made of the required equalization delay. Once this is determined and the ONU receives an equalization delay message, it enters operation state (6) and may begin transmitting data in the upstream direction.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims. For example, in some embodiments, it may be desirable to employ the described downstream or upstream techniques in the other direction, as well or in lieu of the direction for which they are described herein.

1. An optical network node, comprising:
an optical transmitter;
a plurality of optical media access controllers;
a bit interleaver for interleaving the output of each of the plurality of optical media access controllers into a single bit stream and providing the bit stream to the optical transmitter.

2. The optical network node of claim 1, wherein the bit interleaver creates the bit stream by selecting a bit from each of the media access controllers in turn.

3. The optical network node of claim 1, further comprising a phase-lock loop coupled to the bit interleaver and to each of the plurality of optical media access controllers.

4. The optical network node of claim 3, wherein the optical network node is an OLT.

5. The optical network node of claim 4, further comprising an optical receiver.

6. The optical network node of claim 3, wherein the OLT is a node in a passive optical network.

7. The optical network node of claim 6, wherein the optical transmitter transmits at a transmission rate approximately equal to the sum of the operating rates of the plurality of media access controllers.

8. The optical network node of claim 7, wherein the passive optical network is a GPON and the optical transmitter transmission rate is about 10 Gbps.

9. The optical network node of claim 8, wherein the plurality of media access controllers comprises four media access controllers.

10. The optical network node of claim 1, wherein the optical transmitter is in communication with a plurality of ONUs.

11. A method of transmitting an optical signal within a passive optical network, comprising:
receiving, by a bit interleaver of an optical network node, the output of a plurality of media access controllers;
interleaving the output of the plurality of media access controllers to create a single bit stream; and
providing the single bit stream to an optical transmitter.

12. The method of claim 11, wherein the optical network node is an OLT.

13. The method of claim 11, further comprising transmitting the bit stream via a passive optical network.

14. The method of claim 12, further comprising receiving the bit stream in an optical receiver.

15. The method of claim 14, further comprising deinterleaving the bit stream into a plurality of separate bit streams corresponding to the outputs of the respective media access controllers of the optical network node.

16. The method of claim 15, further comprising selecting at least one of the plurality of separate bit streams and providing it to a receiving media access controller.

17. A system for optical communication, comprising
an OLT comprising a bit interleaver; and
at least one ONU in communication with the OLT, the ONU comprising a de-interleaver.

18. The system of claim 17, wherein the ONU is an ONT and comprises a channel selector.

19. The system of claim 17, wherein the ONU is an MDU and comprises a plurality of channel selectors.

20. The system of claim 17, wherein the OLT comprises a plurality of upstream media access controllers.
